(19) United States
(12) Patent Application Publication
(10) Pub. No.: US 2026/0180331 A1
(43) Pub. Date: Jun. 25, 2026

(54) APPARATUS AND METHOD FOR CONTROLLING HOME ENERGY MANAGEMENT SYSTEM

(71) Applicants: HYUNDAI MOTOR COMPANY, Seoul (KR); KIA CORPORATION, Seoul (KR); IUCF-HYU (INDUSTRY-UNIVERSITY COOPERATION FOUNDATION HANYANG UNIVERSITY), Seoul (KR)

(72) Inventors: Dong Hyun Moon, Hwaseong-si (KR); Kyoung Joo Kim, Hwaseong-si (KR); Young Jin Park, Hwaseong-si (KR); Hye Won Kim, Hwaseong-si (KR); Jae Hun Lee, Seoul (KR); Nam Il Kim, Seoul (KR); Hyeong Cheol Lee, Seoul (KR)

(73) Assignees: HYUNDAI MOTOR COMPANY, Seoul (KR); KIA CORPORATION, Seoul (KR); IUCF-HYU (INDUSTRY-UNIVERSITY COOPERATION FOUNDATION HANYANG UNIVERSITY), Seoul (KR)

(21) Appl. No.: 19/251,135

(22) Filed: Jun. 26, 2025

(30) Foreign Application Priority Data
Dec. 24, 2024 (KR) 10-2024-0196349

(51) Int. Cl. H02J 3/32; H02J 3/46; H02J 7/00

(52) U.S. Cl. CPC H02J 3/322; H02J 3/466; H02J 7/82; H02J 7/92; H02J 2105/42

(57) ABSTRACT

An apparatus for controlling a home energy management system (HEMS) includes a communication device connected with the HEMS and a user terminal, storage storing power information of a home power device and a distributed energy resource connected with the HEMS and a rule-based algorithm and an optimization algorithm for controlling the HEMS, and a controller that generates a control strategy for the home power device and the distributed energy resource based on at least one of performance of the rule-based algorithm or the optimization algorithm, the power information of the home power device and the distributed energy resource, or a user setting input from the user terminal, or any combination thereof.

### CROSS REFERENCE TO RELATED APPLICATIONS

This application claims the benefit of priority to Korean Patent Application No. 10-2024-0196349, filed in the Korean Intellectual Property Office on Dec. 24, 2024, the entire contents of which are incorporated herein by reference.

### TECHNICAL FIELD

The present disclosure relates to an apparatus and a method for controlling a home energy management system (HEMS).

### BACKGROUND

A home energy management system (HEMS) is a system for visualizing the energy flow and use of a house using information and communications technology (ICT) and control technology and performing optimal control.

There has been an increase in importance of an energy management industry including the HEMS to overcome energy crisis and achieve stable energy supply. Particularly, with the increase in home power usage due to the commercialization of electric vehicles, there has been a need to develop the HEMS.

An existing EMS study is composed of studies on future load prediction, scheduling considering electricity rates, and an ESS charging and discharging strategy using eco-friendly power generation.

Most studies proceeded via a combination of those listed above and mainly used a heuristic method or an optimization-based method to propose a scheduling and ESS charging and discharging strategy.

However, such an existing technology has the following limitations. Because a rule-based algorithm operates according to a predetermined rule, its capability corresponding to a new situation is restricted. An existing optimization algorithm does not actually and sufficiently reflect data of a microgrid or an EV model or user convenience.

### SUMMARY

The present disclosure has been made to solve the above-mentioned problems occurring in the prior art while advantages achieved by the prior art are maintained intact.

An aspect of the present disclosure provides an apparatus and a method for controlling an HEMS to minimize energy costs incurred from the HEMS even while reflecting user convenience.

Another aspect of the present disclosure provides an apparatus and a method for controlling an HEMS to apply a new power management algorithm to the HEMS to ensure a solution for expanding new electric vehicle (EV) vehicle-to-everything (V2X) energy businesses.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for controlling a home energy management system (HEMS) may include a communication device connected with the HEMS and a user terminal, storage storing power information of a home power device and a distributed energy resource connected with the HEMS and a rule-based algorithm and an optimization algorithm for controlling the HEMS, and a controller that generates a control strategy for the home power device and the distributed energy resource based on at least one of performance of the rule-based algorithm or the optimization algorithm, the power information of the home power device and the distributed energy resource, or a user setting input from the user terminal, or any combination thereof.

In an embodiment, the controller may set an optimization variable about the home power device and the distributed energy resource, if performing the optimization algorithm, may configure an objective function based on the optimization algorithm and the user setting, may calculate an optimization solution in which the user setting is reflected while minimizing a total cost of the objective function, and may generate the control strategy based on the optimization solution.

In an embodiment, the home power device may include a home appliance and a heating, ventilation and air conditioning (HVAC) device and the distributed energy resource includes an energy storage system (ESS) battery and an electric vehicle (EV) battery. The optimization variable may include at least one of operation information, the power information, or an inconvenience index of the home power device and the distributed energy resource. The inconvenience index may reflect a preferred schedulable appliance (SA) time, a preferred EV state of charge (SOC), and a preferred HVAC device temperature input as the user setting.

In an embodiment, the controller may divide the home power device and the distributed energy resource into a first part and a second part, based on a time required for optimization calculation for the home power device and the distributed energy resource, and may perform the optimization algorithm at different periods for the first part and the second part.

In an embodiment, the controller may generate a strategy for home appliance operation time arrangement, if performing the optimization algorithm for the first part, and may generate a strategy for charging and discharging of an ESS battery, charging and discharging of an EV battery, and temperature adjustment of an HVAC device, if performing the optimization algorithm for the second part.

In an embodiment, the rule-based algorithm may include at least one of a home appliance scheduling algorithm, an ESS battery charging and discharging algorithm, an EV battery charging and discharging algorithm, or an HVAC device temperature control algorithm.

In an embodiment, the home appliance scheduling algorithm may reflect the user setting for an operation time and an operation order of home appliances from the user terminal.

In an embodiment, the ESS battery charging and discharging algorithm may determine a night ESS state of charge (SOC) based on a weather state for the next day.

In an embodiment, the EV battery charging and discharging algorithm may reflect a preferred SOC for an EV battery, the preferred SOC being input as the user setting from the user terminal.

In an embodiment, the HVAC device temperature control algorithm may reflect a target temperature, an allowable temperature range, and a comfort level input as the user setting from the user terminal, may change a setting temperature depending a power price for each time, and may follow the target temperature as the comfort level is larger.

In an embodiment, the controller may use an EV battery as an auxiliary battery of an ESS battery, if it is not possible to charge or discharge the ESS battery.

According to another aspect of the present disclosure, a method for controlling a home energy management system (HEMS) may include collecting, by a controller, power information of a home power device and a distributed energy resource connected with the HEMS, receiving, by the controller, a user setting about the home power device and the distributed energy resource from a user terminal, and generating, by the controller, a control strategy for the home power device and the distributed energy resource based on at least one of performance of a rule-based algorithm or an optimization algorithm, the power information of the home power device and the distributed energy resource, or the user setting input from the user terminal, or any combination thereof.

In an embodiment, the generating of the control strategy may include setting an optimization variable about the home power device and the distributed energy resource, if performing the optimization algorithm, configuring an objective function based on the optimization algorithm and the user setting, calculating an optimization solution in which the user setting is reflected while minimizing a total cost of the objective function, and generating the control strategy based on the optimization solution.

In an embodiment, the home power device may include a home appliance and an HVAC device and the distributed energy resource includes an ESS battery and an EV battery. The optimization variable may include at least one of operation information, the power information, or an inconvenience index of the home power device and the distributed energy resource. The inconvenience index may reflect a preferred schedulable appliance (SA) time, a preferred EV state of charge (SOC), and a preferred HVAC device temperature input as the user setting.

In an embodiment, the method may further include dividing, by the controller, the home power device and the distributed energy resource into a first part and a second part, based on a time required for optimization calculation for the home power device and the distributed energy resource, if performing the optimization algorithm, and performing, by the controller, the optimization algorithm at different periods for the first part and the second part.

In an embodiment, the method may further include generating, by the controller, a strategy for home appliance operation time arrangement, if performing the optimization algorithm for the first part, and generating, by the controller, a strategy for charging and discharging of an ESS battery, charging and discharging of an EV battery, and temperature adjustment of an HVAC device, if performing the optimization algorithm for the second part.

In an embodiment, the rule-based algorithm may include a home appliance scheduling algorithm for reflecting the user setting for an operation time and an operation order of home appliances from the user terminal, an ESS battery charging and discharging algorithm for determining a night ESS state of charge (SOC) based on a weather state for the next day, an EV battery charging and discharging algorithm for reflecting a preferred SOC for an EV battery, the preferred SOC being input as the user setting from the user terminal, and an HVAC device temperature control algorithm.

In an embodiment, the HVAC device temperature control algorithm may reflect a target temperature, an allowable temperature range, and a comfort level input as the user setting from the user terminal, may change a setting temperature depending a power price for each time, and may more follow the target temperature in the user setting as the comfort level is larger.

In an embodiment, the method may further include determining, by the controller, whether it is possible to charge or discharge an ESS battery and using an EV battery as an auxiliary battery of the ESS battery, when determining that it is not possible to charge or discharge the ESS battery.

### BRIEF DESCRIPTION OF THE FIGURES

The above and other objects, features and advantages of the present disclosure will be more apparent from the following detailed description taken in conjunction with the accompanying drawings:

FIG. 1 is the overall configuration diagram of a system for controlling an HEMS according to an embodiment of the present disclosure;

FIG. 2 is a detailed configuration diagram of an apparatus for controlling an HEMS according to an embodiment of the present disclosure;

FIG. 3 illustrates an example of a user setting input via a user terminal according to an embodiment of the present disclosure;

FIG. 4 is a table illustrating an example of user setting information according to an embodiment of the present disclosure;

FIG. 5 is an exemplary drawing for describing flow of optimal control according to an embodiment of the present disclosure;

FIGS. 6A, 6B, 6C, and 6D are flow diagrams for performing simulation of a rule-based algorithm according to an embodiment of the present disclosure; and

FIG. 7 is a flowchart for describing a method for controlling an HEMS according to an embodiment of the present disclosure.

### DETAILED DESCRIPTION

Hereinafter, some embodiments of the present disclosure will be described in detail with reference to the example drawings. In adding the reference numerals to the components of each drawing, it should be noted that the identical component is designated by the identical numerals even when they are displayed on other drawings. Further, in describing the embodiment of the present disclosure, a detailed description of well-known features or functions will be ruled out in order not to unnecessarily obscure the gist of the present disclosure.

In describing components of exemplary embodiments of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

A virtual power plant refers to a system for integrating and managing various distributed energy resources. An energy management system (EMS) is a core component of the virtual power plant, which plays a role in monitoring and controlling all resources in the virtual power plant in real time.

The main purpose of the present disclosure is to implement a vehicle-to-home (V2H)-based virtual power plant, which has the following key points.
1) Control a home energy management system (HEMS) by reflecting a setting value of a user
2) Rule-based control or optimization control (model predictive control (MPC))

Hereinafter, a description will be given in detail of control of the HEMS.

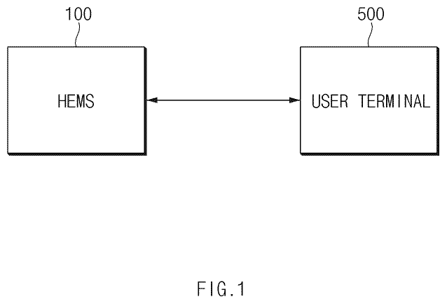

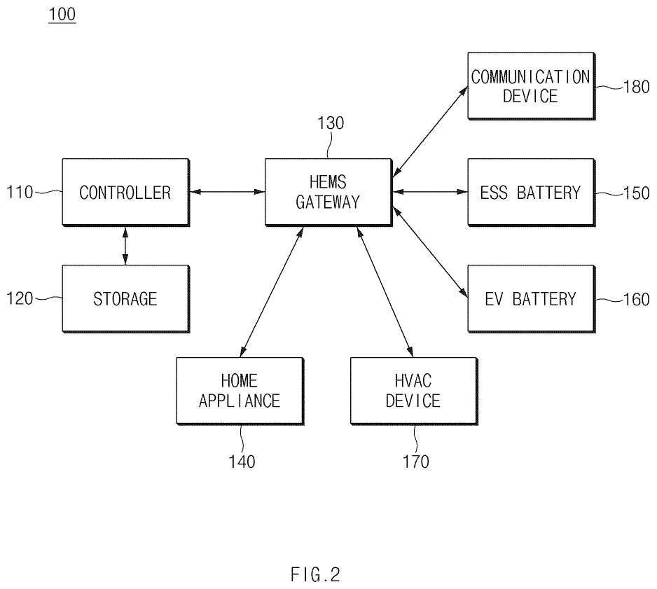

FIG. 1 is the overall configuration diagram of a system for controlling an HEMS according to an embodiment of the present disclosure. FIG. 2 is a detailed configuration diagram of an apparatus for controlling an HEMS according to an embodiment of the present disclosure.

Referring to FIGS. 1 and 2, the system for controlling the HEMS may include an HEMS 100 and a user terminal 500.

The HEMS 100 may be a system installed for each home and may manage energy power supply, consumption, storage, or the like at home.

The user terminal 500 may be a device capable of delivering a user setting input from a user to the HEMS 100 such that convenience of the user is reflected in power management of the HEMS 100. The user terminal 500 may be a terminal device capable of being communicatively connected with the HEMS 100. The user terminal 500 may be implemented as a personal computer (PC), a laptop, a smartphone, a tablet PC, or the like. According to an embodiment, an application for being connected with the HEMS 100 to receive the above-mentioned various pieces of information or controlling a home power device and a distributed energy resource may be installed and executed in the user terminal 500.

Referring to FIG. 2, the apparatus for controlling the HEMS may be configured to include a controller 110, storage 120, an HEMS gateway 130, and a communication device 180.

The communication device 180 connected with the HEMS and a user terminal.

The controller 110 may play a role in controlling the entire configuration and operation of the HEMS.

The storage 120 may store power information associated with a home power device and a distributed energy resource installed at home and a rule-based algorithm and an optimization algorithm for controlling the HEMS. The storage 120 may receive and store the rule-based algorithm and the optimization algorithm from an external server (not shown). As the storage 120 is connected with the external server, the rule-based algorithm and the optimization algorithm may be updated by the external server.

The HEMS gateway 130 may transmit the power information and information about power management to the user terminal 500.

The HEMS gateway 130 may be connected with home power devices associated with power supply, power consumption, or power storage, which is installed or provided at home and may deliver pieces of information received from the connected devices to the controller 110. According to an embodiment, the types of the devices connected with the HEMS gateway 130 may be variously changed.

The HEMS gateway 130 may receive pieces of sensing information detected by various sensors or may receive information about power from the device associated with power management, which is installed at home.

As an embodiment, the HEMS gateway 130 may be connected with at least one of a home appliance 140 or a heating, ventilation and air conditioning (HVAC) device 170, which is a home power device, and may be connected with at least one of an energy storage system (ESS) battery 150 or an electric vehicle (EV) battery 160, which is a distributed energy resource.

It is assumed that the home appliance 140 includes a washing machine, an air conditioner, an oven, and a refrigerator, for example. However, the type of the home appliance 140 may be variously changed.

The ESS battery 150 may store power supplied from a renewable power generation module, a power system, and/or the EV battery 160 or the remaining power which remains after the supplied power is consumed. If it is not possible to charge or discharge the ESS battery 150, the EV battery 160 may be used as an auxiliary battery of the ESS battery 150.

The EV battery 160 may be connected with an electric vehicle (EV) and may use power produced using new renewable energy, such as a photovoltaic module, at home or power supplied via a system network as charging power of the EV or a hybrid electric vehicle (HEV) (hereinafter collectively referred to as the EV). A description will be given of an example of a photovoltaic module as an example of the new renewable energy. However, in addition, it is obvious that various power generation modules, such as a wind power generation module or a hydroelectric power generation module, are adopted and used.

The EV battery 160 may be configured using a plurality of batteries and may be provided as an ESS battery.

The HVAC device 170 may be a device which integrates heating, ventilation and cooling to adjust an indoor environment at home and manage air quality.

The controller 110 may perform the overall power management at home using the received various pieces of information. The controller 110 may check a power state at home, presence/absence of the user, weather, an electricity rate for each time zone, a state of charge (SOC) of the ESS battery 150, an SOC of the EV battery 160, and the like using various pieces of information received from the HEMS gateway 130 or a sensor control device. Based on the checked result, the controller 110 may generate a control strategy for controlling operations of the home power devices 140 and 170 and the distributed energy resources 150 and 160 connected with the HEMS gateway 130, may generate a control signal based on the control strategy, and may transmit the generated control signal to the HEMS gateway 130 or the sensor control device.

In other words, an entity which controls the overall operation of the HEMS according to an embodiment of the present disclosure may correspond to the controller 110. It is possible for the controller 110 to be implemented as an embedded controller or an Amazon web service (AWS) cloud server.

The controller 110 may minimize energy costs incurred from the HEMS while reflecting a user setting input by the user in the home power device and the distributed energy resource.

To this end, the controller 110 may generate a control strategy for the home power device and the distributed energy resource based on at least one of the performance of the rule-based algorithm or the optimization algorithm, power information of the home power device and the distributed energy resource, or the user setting input from the user terminal, or any combination thereof.

In the present disclosure, the rule-based algorithm is an algorithm which controls the HEMS 100 depending to a predetermined rule and includes capability corresponding to a new situation including the user setting.

An MPC algorithm adopted in the present disclosure is an algorithm implemented in the form of combining a mixed integer linear programming (MILP) optimization algorithm and a sliding horizon strategy.

The controller 110 may set an optimization variable about the home power device and the distributed energy resource, if performing the MILP optimization algorithm, may configure an objective function based on the optimization variable and the user setting, may calculate an optimization solution in which the user setting is reflected while minimizing a total cost of the objective function, and may generate a control strategy for the home power device and the distributed energy resource based on the optimization solution.

The optimization variable may include at least one of operation information, the power information, or an inconvenience index of the home power device and the distributed energy resource.

The optimization variable is in detail as follows. A binary variable may be used to satisfy operation conditions of some micro-grid components. An optimization problem may be implemented using the MILP to reflect a characteristic of the binary variable.

### Optimization Variable

The amount of power [W] assigned to the step j of the home appliance i during the time slot k:

$${P}_{ij}^{k}$$

If the specific step of the home appliance is operating during the time slot k, it is 1, and if not, it is 0 [0-1]:

$${x}_{ij}^{k}$$

If the specific step of the home appliance ends during the time slot k, it is 1, and if not, it is 0 [0-1]:

$${S}_{ij}^{k}$$

The actual operation time [Time] of the home appliance i: T_{i,start}

The inconvenience index [−] of the home appliance i: D_{app,i}

If purchasing power from the grid in time slot k, it is 1, and if discharging power to the grid, it is 0 [0-1]:

$${Grid}_{mode}^{k}$$

If the ESS/EV is in the charging mode in the time slot k, it is 1, and if it is in the discharging mode, it is 0 [0-1]:

$${ESS}_{mode}^{k} , {EV}_{mode}^{k}$$

The ESS/EV remaining energy [Wh] in the time slot k:

$${E}_{ESS}^{k} , {E}_{EV}^{k}$$

The EV inconvenience Index [−] in the time slot k:

$${D}_{EV}^{k}$$

The microgrid power [W] in the time slot k:

$${P}_{PV 2 Load}^{k} , {P}_{PV 2 Grid}^{k} , {P}_{PV 2 ESS}^{k} , {P}_{PV 2 EV}^{k} , {P}_{Grid 2 EV}^{k} , {P}_{Grid 2 Load}^{k} , {P}_{ESS 2 Grid}^{k} , \\ {P}_{ESS 2 Load}^{k} , {P}_{ESS 2 EV}^{k} , {P}_{EV 2 Grid}^{k} , {P}_{EV 2 Load}^{k} , {P}_{PV 2 ESS}^{k} , {P}_{Grid 2 ESS}^{k}$$

If the EV is plugged out, the remaining energy [Wh]:

$${E}_{EV}^{PlugOut}$$

The cooling/heating capacity [W] of the HVAC home appliance in the time slot k:

$${Φ}_{cool}^{k} , {Φ}_{heat}^{k}$$

The cooling/heating power consumption [W] of the HVAC home appliance in the time slot k:

$${P}_{cool}^{k} , {P}_{heat}^{k}$$

The target temperature, the room temperature, and the wall temperature [° C.] set by the HVAC home appliance in the time slot k:

$${t}_{set}^{k} , {t}_{in}^{k} , {t}_{w}^{k}$$

The temperature inconvenience Index [−] in the time slot k:

$${D}_{temp}^{k}$$

### Organized Optimization Variable (Sign: +)

$$PV power : {P}_{PV}^{k} = {P}_{PV 2 Load}^{k} + {P}_{PV 2 Grid}^{k} + {P}_{PV 2 Grid}^{k} + {P}_{PV 2 ESS}^{k} + {P}_{PV 2 EV}^{k}$$

$$Grid export power : {P}_{{grid}_{ex}}^{k} = {P}_{PV 2 Grid}^{k} + {P}_{ESS 2 Grid}^{k} + {P}_{EV 2 Grid}^{k}$$

$$Grid import power : {P}_{{grid}_{im}}^{k} = {P}_{Grid 2 ESS}^{k} + {P}_{Grid 2 EV}^{k} + {P}_{Grid 2 Load}^{k}$$

$$ESS charging power : {P}_{ESS , Chg}^{k} + {P}_{PV 2 ESS}^{k} + {P}_{Grid 2 ESS}^{k} + {P}_{EV 2 ESS}^{k}$$

$$ESS discharging power : {P}_{ESS , Dis}^{k} + {P}_{ESS 2 Grid}^{k} + {P}_{ESS 2 Load}^{k} + {P}_{ESS 2 EV}^{k}$$

$$EV charging power : {P}_{EV , Chg}^{k} = {P}_{PV 2 EV}^{k} + {P}_{Grid 2 EV}^{k} + {P}_{ESS 2 EV}^{k}$$

$$EV discharging power : {P}_{EV , Dis}^{k} = {P}_{EV 2 Grid}^{k} + {P}_{EV 2 Load}^{k} + {P}_{EV 2 ESS}^{k}$$

The MILP optimization algorithm may have the following constraints. The constraints may reflect a static characteristic of a microgrid component, a dynamic characteristic of the microgrid component, and an expected value of a user.

### Load Constraints:

$${P}_{ij}^{k} = {P}_{ij} {x}_{ij}^{k} , ∀ I , j , k$$

$${\sum }_{k = 1}^{m} {x}_{ij}^{k} = {T}_{ij} , ∀ I , j$$

### ESS Constraints:

$${E}_{ESS} \leq {E}_{ESS}^{k} \leq {\overline{E}}_{ESS} , ∀ I , j$$

$${E}_{ESS}^{k} = {E}_{ESS}^{k - 1} + ( η \cdot {p}_{ESS , Chg}^{k - 1} - \frac{1}{η} \cdot {p}_{ESS , Dis}^{k - 1} ) \cdot dt , ∀ k$$

### EV Constraints:

$${E}_{EV} \leq {E}_{EV}^{k} \leq {\overline{E}}_{EV} , ∀ k$$

$${E}_{EV}^{k} = ( 1 - {E}_{PlugInTrig}^{k} ) \cdot \{ {E}_{EV}^{k - 1} + ( η \cdot {p}_{EV , Chg}^{k - 1} - \frac{1}{η} \cdot {p}_{EV , Dis}^{k - 1} ) \cdot dt \} + {EV}_{PlugInTrig}^{k} \cdot ( {E}_{EV}^{PlugOut} - {E}_{EV , drive} ) , ∀ k$$

### HVAC Constraints:

$${t}_{in}^{k} = {t}_{in}^{k - 1} + ( - {Φ}_{cool}^{k} + \frac{{t}_{in}^{k} - {t}_{w}^{k}}{{R}_{win}} + \frac{{t}_{out}^{k} - {t}_{in}^{k}}{{R}_{V}} ) \cdot dt \cdot \frac{3600}{{c}_{air}} , ∀ k$$

$${t}_{w}^{k} = {t}_{w}^{k - 1} + ( \frac{{t}_{in}^{k} - {t}_{w}^{k}}{{R}_{win}} + \frac{{t}_{out}^{k} - {t}_{w}^{k}}{{R}_{wout}} + \frac{{t}_{rooms}^{k} - {t}_{w}^{k}}{{R}_{rooms}} + \frac{{t}_{ground}^{k} - {t}_{in}^{k}}{{R}_{ground}} ) \cdot dt \cdot \frac{3600}{{c}_{w}} , ∀ k$$

### Microgrid Constraints:

$${P}_{PV 2 Load}^{k} + {P}_{Grid 2 Load}^{k} + {P}_{ESS 2 Load}^{k} + {P}_{EV 2 Load}^{k} = {\sum }_{i = 1}^{N} {\sum }_{j = 1}^{{n}_{j}} {p}_{ij}^{k} {HVAC}_{ON , cool}^{k} \cdot {p}_{cool}^{k} + {HVAC}_{ON , heat}^{k} \cdot {p}_{heat}^{k} + {p}_{Fixed}^{k} , ∀ k$$

$${\sum }_{i = 1}^{N} {\sum }_{j = 1}^{{n}_{j}} {p}_{ij}^{k} + {p}_{Fixed}^{k} \leq {PEAK}^{k} , ∀ k$$

The inconvenience index may reflect a preferred schedulable appliance (SA) time, a preferred EV state of charge (SOC), and a preferred HVAC device temperature, which are input as user settings.

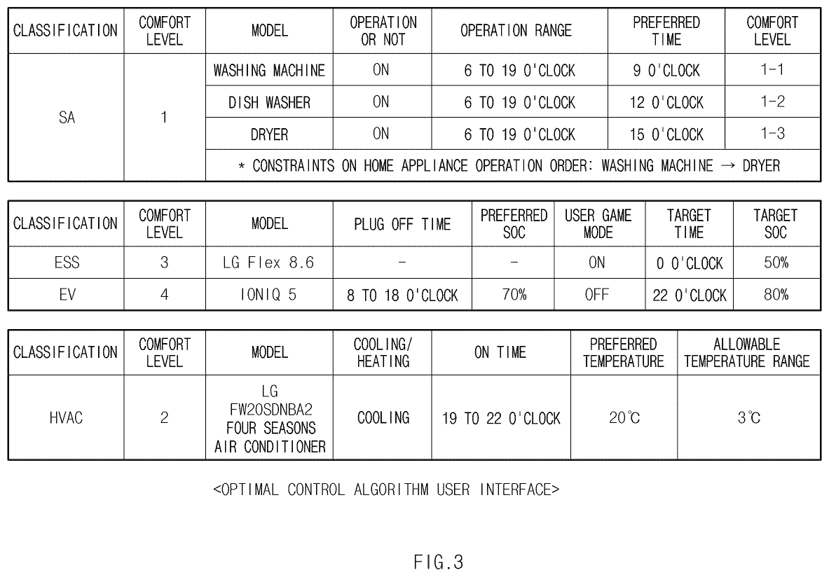

FIG. 3 illustrates an example of a user setting input via a user terminal according to an embodiment of the present disclosure. Referring to FIG. 3, a user may access an optimal control algorithm via an interface shown in FIG. 3. A comfort level may be reflected in a comfort item weight of an objective function. A preferred SA time, a preferred EV SOC, and a preferred HVAC device temperature may be used to calculate an inconvenience index and the remaining input values may be reflected in all constraints of the optimization algorithm.

Via the interface shown in FIG. 3, the user may enter a preferred operation time, a comfort level, and the like for a home appliance, may enter a preferred temperature, an allowable temperature range, a comfort level, and the like for an HVAC device, and may enter a preferred SOC, a target time, a target SOC, a comfort level, and the like for an ESS battery and an EV battery.

For example, the home appliance may be set to a comfort ranking entered by the user as its comfort level is “1”. The HVAC device may be set to a comfort ranking entered by the user as its comfort level is “2”. The ESS battery may be set to a comfort ranking entered by the user as its comfort level is “3”. The EV battery may be set to a comfort ranking entered by the user as its comfort level is “4”. A sub-level ranking may be set to each of the home appliance, the HVAC device, the ESS battery, and the EV battery. For example, even in the home appliance, the comfort level of which is set to “1”, the sub-level of the washing machine may be further set to “1-1”, the sub-level of the dish washer may be further set to “1-2”, and the sub-level of the dryer may be further set to “1-3”.

The larger the comfort level is set to be, the more the weight in optimization calculation may increase and the larger the priority may be set to be in calculating a solution of optimization calculation.

In detail, the objective function may be composed of the sum of an energy cost item, a home appliance comfort item, an EV battery comfort item, and a temperature comfort item. Each of the home appliance comfort item, the EV battery comfort item, and the temperature comfort item may be calculated based on the weight and the inconvenience index.

The objective function may be defined by Equation 1 below, for a scheduling period T.

$${{\sum }_{k = 1}}^{m} ( {c}_{im}^{k} \cdot {P}_{{grid}_{im}}^{k} - {c}_{ex}^{k} \cdot {P}_{{grid}_{ex}}^{k} ) dt + β \cdot {{\sum }_{i = 1}}^{N} {α}_{i} {D}_{app , i} + γ \cdot {{\sum }_{k = 1}}^{m} {D}_{EV}^{k} + δ \cdot {{\sum }_{k = 1}}^{m} {D}_{temp}^{k} \qquad Equation 1$$

Herein, N: the number of controllable home appliances, m: the number of time slots during the scheduling period,

$${c}_{im}^{k} :$$

the power purchase fee [$/kWh] in the time slot k,

$${c}_{ex}^{k} :$$

the power sales fee [$/kWh] in the time slot k,

$${P}_{{grid}_{im}}^{k} :$$

the grid import power [kW] in the time slot k,

$${P}_{{grid}_{ex}}^{k} :$$

the grid export power [kW] in the time slot k, dt: the length [h] of the time slot, Dᵢ: the inconvenience index of the home appliance i, β: the weight of the home appliance inconvenience Index, γ: the weight of the EV inconvenience index, δ: the weight of the temperature inconvenience Index,

$${D}_{EV}^{k} :$$

the EV inconvenience index in the time slot k, and

$${D}_{temp}^{k} :$$

the temperature inconvenience Index in the time slot k.

Herein, each inconvenience Index may be calculated as:

$${D}_{app , i} \geq ( {T}_{i , User} - {T}_{i , start} ) / 24 , {D}_{app , i} \geq ( {T}_{i , start} - {T}_{i , User} ) / 24 , ∀ i$$

$${D}_{EV}^{k} \geq ( {E}_{EV , Target} - {E}_{EV}^{k} ) / {EV}_{Capacity} , {D}_{EV}^{k} \geq 0 , ∀ k$$

$${D}_{temp}^{k} \geq {t}_{user} - {t}_{in}^{k} , {D}_{temp}^{k} \geq {t}_{in}^{k} - {t}_{user}^{k} , ∀ k .$$

T_{i,user} denotes the operation start time of the home appliance i desired by the user, T_{i,start} denotes the actual operation start time of the home appliance i,

$${E}_{EV}^{k}$$

denotes the remaining EV energy [Wh] in the time slot k, E_{EV,Target} denotes the preferred EV energy [Wh] specified by the user, EV_{Capacity} denotes the EV capacity [Wh],

$${t}_{in}^{k}$$

denotes the room temperature [° C.] in the time slot k, tᵤₛₑᵣ denotes the target temperature [C] specified by the user, and i∈[1, N], j∈[1, nᵢ], k∈[1, m].

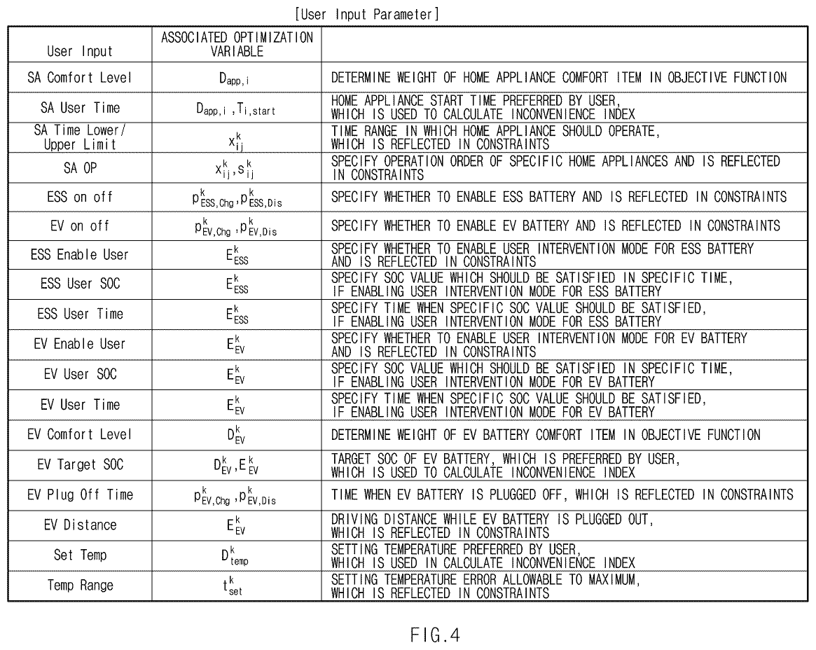

FIG. 4 is a table illustrating an example of user setting information according to an embodiment of the present disclosure.

Referring to FIG. 4, an SA comfort level input as user setting information may be used to determine a weight of a home appliance comfort item in an objective function and an SA user time may be a home appliance start time preferred by a user, which may be used to calculate an inconvenience index. An SA time lower/upper limit may be a time range in which a home appliance should operate, which may be reflected in constraints. An SA OP may specify an operation order of specific home appliances and may be reflected in the constraints. ESS on off may specify whether to enable the ESS battery and may be reflected in the constraints. EV on off may specify whether to enable the EV battery and may be reflected in the constraints. An ESS enable user may specify whether to enable a user intervention mode for the ESS battery and may be reflected in the constraints. An ESS user SCO may specify an SOC value which should be satisfied in a specific time, if enabling the user intervention mode for the ESS battery, and may be reflected in the constraints. An ESS user time may specify a time when a specific SOC value should be satisfied, if enabling the user intervention mode for the ESS battery, and may be reflected in the constraints. An EV enable user may specify whether to enable the user intervention mode for the EV battery and may be reflected in the constraints. An EV user SCO may specify an SOC value which should be satisfied in a specific time, if enabling a user intervention mode for the EV battery, and may be reflected in the constraints. An EV user time may specify a time when a specific SOC value should be satisfied, if enabling the user intervention mode for the EV battery, and may be reflected in the constraints. An EV comfort level may be used to determine a weight of an EV battery comfort item in an objective function. An EV target SOC may be a target SOC of the EV battery, which is preferred by the user, which may be used to calculate an inconvenience index. An EV plug off time may be a time when the EV battery is plugged off, which may be reflected in the constraints. An EV distance may be a driving distance while the EV battery is plugged out, which may be reflected in the constraints.

Meanwhile, a controller 110 may divide a home power device and a distributed energy resource into a first part and a second part, based on a time required for optimization calculation for the home power device and the distributed energy resource and may perform the above-mentioned optimization algorithm at different periods for the first part and the second part.

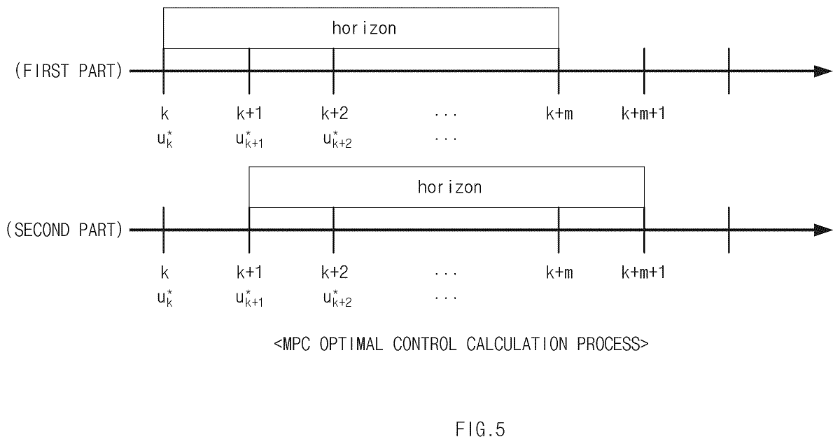

FIG. 5 is an exemplary drawing for describing flow of optimal control according to an embodiment of the present disclosure.

Referring to FIG. 5, an HEMS may classify a home power device and a distributed energy resource into a first part and a second part and may execute optimal control at a different period for each part.

In an embodiment, an MILP optimization process may proceed by dividing the home power device and the distributed energy resource into a part (or a first part) for optimizing a home appliance, an ESS battery, an EV battery, and an HVAC device in an integrated manner and a part (or a second part) for optimizing the ESS battery, the EV battery, and the HVAC device.

For example, optimization may proceed by specifying the horizon as 12 hours while performing integrated optimization every 10 seconds for the integrated optimization and specifying the horizon as 6 hours while performing separation optimization every 5 seconds for the separation optimization.

It is preferable to optimize logic in which it takes a longer optimization calculation time between the first part and the second part at a longer period.

For optimization for the home appliance, there are many optimization variables and an optimality difference between having a short period and having a long period is not large.

On the other hand, for optimization for the ESS battery, the EV battery, and the HVAC device, executing optimization at a short period is advantageous to ensure optimality of the solution.

Thus, the home appliance in which it takes a long optimization calculation time and there is no need to proceed with optimization at a short period may perform optimization at a longer period to reduce a calculation resource. The EV battery, the ESS battery, and the HVAC device may more frequently execute optimization calculation to ensure optimality in charging and discharging control of the ESS battery and the EV battery.

Optimization for the first part may be executed at an integrated optimization period or if an interrupt occurs to perform operation time arrangement of the home appliance. Optimization for the second part may be executed per minimum period of an MPC algorithm to perform optimal control for charging and discharging power of the ESS battery and the EV battery and a setting temperature value of the HVAC device based on the operation time displacement information of the home appliance.

A solution is derived at a different period for each part and an optimal solution for the first part and an optimal solution for the second part are independent of each other.

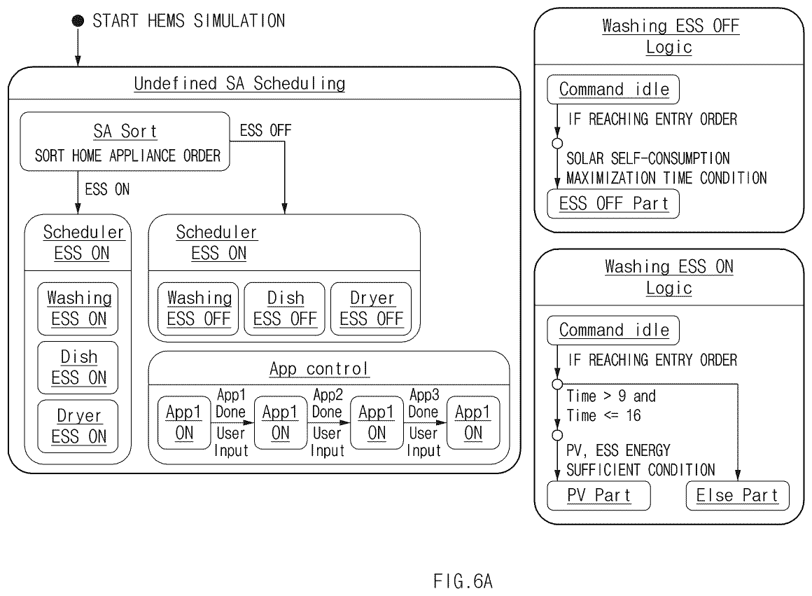

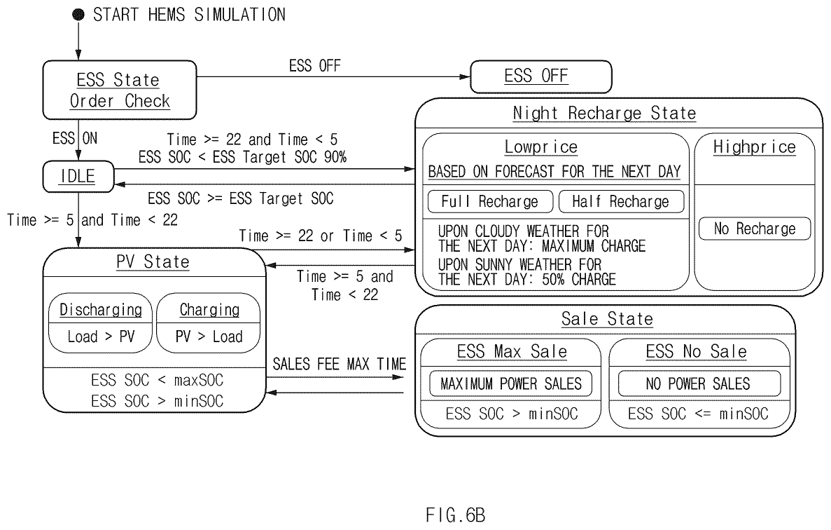

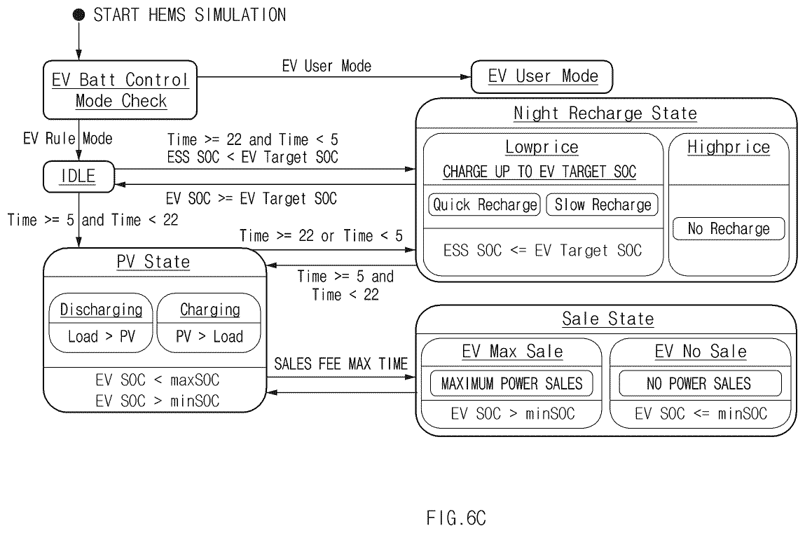

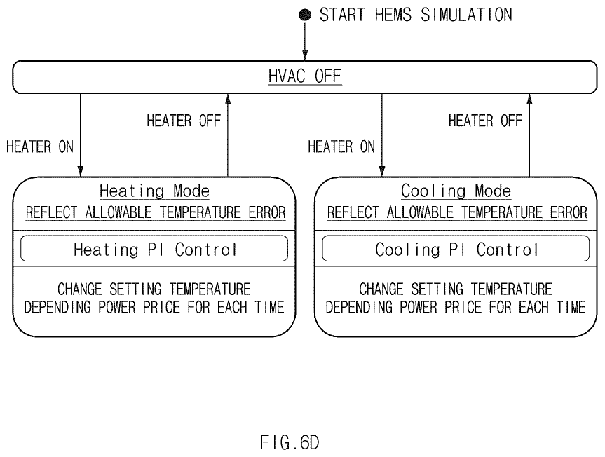

FIGS. 6A to 6D are flow diagrams for performing simulation of a rule-based algorithm according to an embodiment of the present disclosure.

Referring to FIGS. 6A to 6D, the rule-based algorithm may include at least one of a home appliance scheduling algorithm, an ESS battery charging and discharging algorithm, an EV battery charging and discharging algorithm, or an HVAC device temperature control algorithm.

Referring to FIG. 6A, the home appliance scheduling algorithm may reflect a user setting for an operation time and an operation order of home appliances, which are input from a user terminal 500.

Referring to FIG. 6B, the ESS battery charging and discharging algorithm may determine a night ESS battery state or charge (SOC) based on a weather state for the next day. In an embodiment, the ESS battery charging and discharging algorithm may set the night ESS battery SOC to the maximum, if a forecast of cloudy weather for the next day is received, and may set the night ESS battery SOC to 50%, if a forecast of sunny weather for the next day is received.

Referring to FIG. 6C, the EV battery charging and discharging algorithm may reflect a preferred SOC for an EV battery, which is input as the user setting from the user terminal 500.

If it is not possible to charge or discharge the ESS battery, the ESS battery may be used as an auxiliary battery of the ESS battery. This is based on a vehicle-to-grid (V2G) function of transmitting power charged in the EV battery to a power grid again. As a result, via the EV battery charging and discharging algorithm, the user may charge the EV battery in a time zone when the electricity rate is low and may sell the charged electricity in a time zone when the electricity rate is high to make profit, thus helping stabilize the power grid. For example, the user may produce electricity using solar panels installed on the roof of a house or a building and may store the electricity in the EV battery during the daytime and may use the stored electricity if necessary at night.

Referring to FIG. 6D, the HVAC device temperature control algorithm may reflect a target temperature, an allowable temperature range, and a comfort level, which are input as the user setting from the user terminal 500. As an embodiment, the HVAC device temperature control algorithm may change a setting temperature depending on a power price (i.e., cost of the power) for each time, and may follow a target temperature as the comfort level is larger.

As the comfort level increases (i.e., the user requires a higher degree of thermal comfort), the HVAC system tends to more precisely follow the target temperature set by the user.

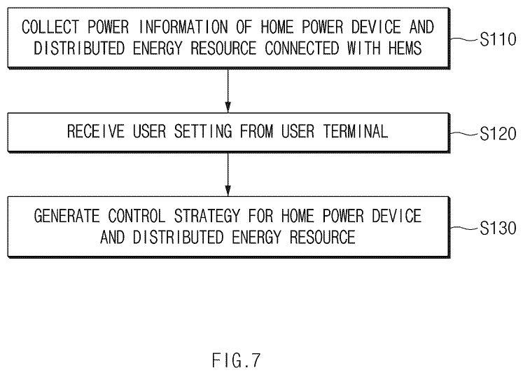

FIG. 7 is a flowchart for describing a method for controlling an HEMS according to an embodiment of the present disclosure. Hereinafter, a detailed description of the same configuration as the apparatus for controlling the HEMS and a function thereof, which are described with reference to FIGS. 1 to 6, may be partially omitted.

Referring to FIG. 7, in the method for controlling the HEMS according to an embodiment of the present disclosure, first of all, in S110, a controller may collect power information of a home power device and a distributed energy resource connected with the HEMS.

Next, in S120, the controller may receive a user setting about the home power device and the distributed energy resource from a user terminal.

Next, in S130, the controller may generate a control strategy for the home power device and the distributed energy resource based on at least one of performance of a rule-based algorithm or an optimization algorithm, the power information of the home power device and the distributed energy resource, or the user setting input from the user terminal, or any combination thereof.

According to the present disclosure, the apparatus for controlling the HEMS may minimize energy costs incurred from the HEMS while reflecting user convenience.

Furthermore, according to the present disclosure, the apparatus for controlling the HEMS may efficiently manage complex requirements of a home power system to satisfy the intention and convenience of the user and the efficiency of the system at the same time.

In addition, according to the present disclosure, the apparatus for controlling the HEMS may implement an HEMS control environment via a cloud computing environment and may set a low terminal price to facilitate service sales, even for home where an existing hardware environment is not constructed.

In addition, according to the present disclosure, the apparatus for controlling the HEMS may provide a user-friendly service capable of reflecting a setting value of the user via an application and monitoring a home power environment in real time.

According to the present disclosure, the apparatus for controlling the HEMS may minimize energy costs incurred from the HEMS even while reflecting user convenience.

Furthermore, according to the present disclosure, the apparatus for controlling the HEMS may efficiently manage complex requirements of a home power system, thus satisfying the intention and convenience of the user and the efficiency of the system at the same time.

In addition, according to the present disclosure, the apparatus for controlling the HEMS may implement an HEMS control environment via a cloud computing environment, thus setting a low terminal price to facilitate service sales, even for home where an existing hardware environment is not constructed.

In addition, according to the present disclosure, the apparatus for controlling the HEMS may provide a user-friendly service capable of reflecting a setting value of the user via an application and monitoring a home power environment in real time.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims. Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

1. An apparatus for controlling a home energy management system (HEMS), the apparatus comprising:
a communication device connected with the HEMS and a user terminal;
a storage configured to store power information of a home power device and a distributed energy resource connected with the HEMS, and to store a rule-based algorithm and an optimization algorithm for controlling the HEMS; and
a controller configured to generate a control strategy for the home power device and the distributed energy resource based on at least one of performance of the rule-based algorithm or the optimization algorithm, the power information of the home power device and the distributed energy resource, or a user setting input from the user terminal, or any combination thereof.

2. The apparatus of claim 1, wherein the controller is further configured to:
set an optimization variable for the home power device and the distributed energy resource, when performing the optimization algorithm;
configure an objective function based on the optimization algorithm and the user setting;
calculate an optimization solution where the user setting is determined while minimizing a total cost of the objective function; and
generate the control strategy based on the optimization solution.

3. The apparatus of claim 2, wherein the home power device includes a home appliance and a heating, ventilation, and air conditioning (HVAC) device, and wherein the distributed energy resource includes an energy storage system (ESS) battery and an electric vehicle (EV) battery;
wherein the optimization variable includes at least one of operation information, the power information, or an inconvenience index of the home power device and the distributed energy resource; and
wherein the inconvenience index includes a preferred schedulable appliance (SA) time, a preferred EV state of charge (SOC), and a preferred HVAC device temperature input as the user setting.

4. The apparatus of claim 1, wherein the controller is further configured to:
divide the home power device and the distributed energy resource into a first part and a second part based on a time required for optimization calculation for the home power device and the distributed energy resource; and
perform the optimization algorithm at a first period for the first part and a second period for the second part, where the first period is different from the second period.

5. The apparatus of claim 4, wherein the controller is further configured to:
generate a strategy for home appliance operation time arrangement, when performing the optimization algorithm for the first part; and
generate a strategy for charging and discharging of an ESS battery, charging and discharging of an EV battery, and temperature adjustment of an HVAC device, when performing the optimization algorithm for the second part.

6. The apparatus of claim 1, wherein the rule-based algorithm includes at least one of a home appliance scheduling algorithm, an ESS battery charging and discharging algorithm, an EV battery charging and discharging algorithm, or an HVAC device temperature control algorithm.

7. The apparatus of claim 6, wherein the home appliance scheduling algorithm is configured to determine the user setting for an operation time and an operation order of home appliances from the user terminal.

8. The apparatus of claim 6, wherein the ESS battery charging and discharging algorithm is configured to determine a night ESS state of charge (SOC) based on a weather state for a next day.

9. The apparatus of claim 6, wherein the EV battery charging and discharging algorithm is configured to determine a preferred SOC for an EV battery, the preferred SOC being input as the user setting from the user terminal.

10. The apparatus of claim 7, wherein the HVAC device temperature control algorithm is configured to:
determine a target temperature, an allowable temperature range, and a comfort level input as the user setting from the user terminal;
change a setting temperature depending on a power price for each operation time; and
follow the target temperature as the comfort level increases.

11. The apparatus of claim 1, wherein the controller is configured to:
use an EV battery as an auxiliary battery of an ESS battery, when it is not possible to charge or discharge the ESS battery.

12. A method for controlling a home energy management system (HEMS), the method comprising:
collecting, by a controller, power information of a home power device and a distributed energy resource connected with the HEMS;
receiving, by the controller, a user setting for the home power device and the distributed energy resource from a user terminal;
generating, by the controller, a control strategy for the home power device and the distributed energy resource based on at least one of performance of a rule-based algorithm or an optimization algorithm, the power information of the home power device and the distributed energy resource, or the user setting input from the user terminal, or any combination thereof; and
performing at least one of the rule-based algorithm and the optimization algorithm.

13. The method of claim 12, wherein the generating of the control strategy includes:
setting an optimization variable for the home power device and the distributed energy resource, when performing the optimization algorithm;
configuring an objective function based on the optimization algorithm and the user setting;
calculating an optimization solution where the user setting is determined while minimizing a total cost of the objective function; and
generating the control strategy based on the optimization solution.

14. The method of claim 13, wherein the home power device includes a home appliance and an HVAC device, and the distributed energy resource includes an ESS battery and an EV battery;
wherein the optimization variable includes at least one of operation information, the power information, or an inconvenience index of the home power device and the distributed energy resource; and
wherein the inconvenience index includes a preferred schedulable appliance (SA) time, a preferred EV state of charge (SOC), and a preferred HVAC device temperature input as the user setting.

15. The method of claim 12, further comprising:
dividing, by the controller, the home power device and the distributed energy resource into a first part and a second part, based on a time required for optimization calculation for the home power device and the distributed energy resource, when performing the optimization algorithm; and
performing, by the controller, the optimization algorithm at a first period for the first part and a second period for the second part, where the first period is different from the second period.

16. The method of claim 15, further comprising:
generating, by the controller, a strategy for home appliance operation time arrangement, when performing the optimization algorithm for the first part; and
generating, by the controller, a strategy for charging and discharging of an ESS battery, charging and discharging of an EV battery, and temperature adjustment of an HVAC device, when performing the optimization algorithm for the second part.

17. The method of claim 12, wherein the rule-based algorithm includes:
a home appliance scheduling algorithm for determining the user setting for an operation time and an operation order of home appliances from the user terminal;
an ESS battery charging and discharging algorithm for determining a night ESS state of charge (SOC) based on a weather state for a next day;
an EV battery charging and discharging algorithm for determining a preferred SOC for an EV battery, the preferred SOC being input as the user setting from the user terminal; and
an HVAC device temperature control algorithm.

18. The method of claim 17, wherein the HVAC device temperature control algorithm is configured to:
determine a target temperature, an allowable temperature range, and a comfort level input as the user setting from the user terminal;
change a setting temperature depending on a power price for each operation time; and
more follow the target temperature in the user setting as the comfort level increases.

19. The method of claim 12, further comprising:
determining, by the controller, whether it is possible to charge or discharge an ESS battery; and
using, by the controller, an EV battery as an auxiliary battery of the ESS battery, when determining that it is not possible to charge or discharge the ESS battery.
